(19) United States
(12) Patent Application Publication
(10) Pub. No.: US 2026/0202999 A1
(43) Pub. Date: Jul. 16, 2026

(54) STORAGE MEDIUM, INFORMATION PROCESSING APPARATUS, AND METHOD OF CONTROLLING INFORMATION PROCESSING APPARATUS

(71) Applicant: CANON KABUSHIKI KAISHA, Tokyo (JP)

(72) Inventor: Natsumi Tokunaga, Kanagawa (JP)

(21) Appl. No.: 19/439,728

(22) Filed: Jan. 5, 2026

(30) Foreign Application Priority Data
Jan. 14, 2025 (JP) 2025-004740

(51) Int. Cl. G06F 3/12

(52) U.S. Cl. CPC G06F 3/1205; G06F 3/1256; G06F 3/1258

(57) ABSTRACT

A storage medium stores a control method executed by an information processing apparatus, and the method includes: selecting print target data; displaying a change screen for changing print setting used in printing based on the selected print target data; controlling the change screen to include an area for changing date printing setting, based on a fact that predetermined information is assigned to the selected print target data; controlling printing based on the print target data so as to print a character string corresponding to date information included in the predetermined information, in a case where setting corresponding to execution of the date printing is configured as the date printing setting; and executing processing for printing based on the print target data.

### BACKGROUND

### Filed of the Technology

The present disclosure relates to a date printing technique.

### Description of the Related Art

With the recent advancement of digitalization, there has been an increasing demand among individuals and companies for date printing to print the date on an image to be printed. However, print data does not always include photographing date information, thus leading to a problem that date printing cannot be performed depending on the selected print data. Japanese Patent Laid-Open No. 2009-005344 discloses a method of printing the date using photographing date information if print data includes that information, or using the file creation date or update date information if no photographing date information is included.

There is a demand for improving usability of date printing.

### SUMMARY

A storage medium according to the present disclosure is a non-transitory computer readable storage medium storing a program which causes a computer to execute a method of controlling an information processing apparatus, and the method includes: a selecting step of selecting print target data; a first displaying step of displaying a change screen for changing print setting used in printing based on the selected print target data; a first controlling step of controlling the change screen to include an area for changing date printing setting, based on a fact that predetermined information is assigned to the selected print target data, and controlling the change screen to not include the area for changing the date printing setting, based on a fact that the predetermined information is not assigned to the selected print target data; a second controlling step of controlling printing based on the print target data so as to print a character string corresponding to date information included in the predetermined information, in a case where setting corresponding to execution of the date printing is configured as the date printing setting, and controlling printing based on the print target data so as not to print the character string corresponding to the date information included in the predetermined information, in a case where setting corresponding to non-execution of the date printing is configured as the date printing setting; and an executing step of executing processing for printing based on the print target data.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram showing an example of date printing

FIG. 2 is a diagram showing a configuration example of a communication apparatus capable of communicating with an information processing apparatus;

FIG. 3 is a diagram showing a configuration example of a communication application;

FIG. 4 is a flowchart showing a processing flow from image data selection to preview display;

FIG. 5 is a diagram showing an example of a communication application GUI for selecting image data;

FIG. 6 is a flowchart showing a flow of date information obtaining processing;

FIG. 7A is a diagram showing an example of a communication application GUI for displaying a preview of image data;

FIG. 7B is a diagram showing an example of the communication application GUI for displaying a preview of image data;

FIG. 7C is a diagram showing an example of the communication application GUI for displaying a preview of image data;

FIG. 8A is a diagram showing an example of a communication application GUI for changing print setting;

FIG. 8B is a diagram showing an example of the communication application GUI for changing the print setting;

FIG. 8C is a diagram showing an example of the communication application GUI for changing the print setting; and

FIG. 9 is a flowchart showing a processing flow up to transmission of print data to the communication apparatus.

### DESCRIPTION OF THE EMBODIMENTS

Hereinafter, embodiments of the present disclosure are described with reference to the accompanying drawings. The following embodiments do not limit the present disclosure, and not all the combinations of features described in the embodiments are essential to the solution of the present disclosure. The same components are described with the same reference numerals. The steps in the flowcharts are denoted by reference numerals starting with "S".

### First Embodiment

An overview of the present embodiment will be described. In a case where date printing is performed, a user often assumes that the date of photographing is printed. In a case where print data includes no photographing date information, the update date of the print data file may differ from the photographing date. In such a case, in a case where the update date of the print data file is printed as the date, the user may mistake the update date of the printed file for the actual date of photographing. Therefore, the following description of embodiments is given of processing for accurately obtaining photographing date information. This provides an example of how usability is improved.

An information processing apparatus and a communication apparatus included in a print system of the present embodiment will be described. An example of the information processing apparatus described in the present embodiment is, but not limited to, a smartphone. The information processing apparatus may also be a mobile terminal, laptop PC, tablet terminal, personal digital assistant (PDA), digital camera, or the like. An apparatus capable of wireless communication with the information processing apparatus and printing by receiving print data from the information processing apparatus can be used as the communication apparatus. For example, an electrophotographic printer such as a laser beam printer can be used as the communication apparatus (printing apparatus). In addition, a multifunction peripheral equipped with a plurality of functions, such as copy function, FAX function, print function, and scanner function, can also be used as the communication apparatus (printing apparatus). In other words, an electrophotographic multifunction peripheral can also be used as the communication apparatus (printing apparatus). In the present embodiment, the communication apparatus (printing apparatus) is assumed to be the electrophotographic printer or electrophotographic multifunction peripheral.

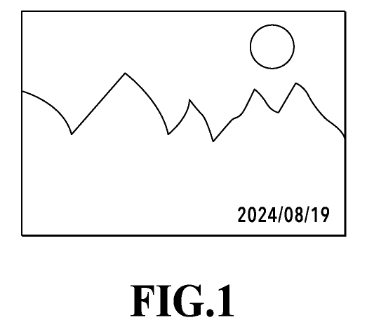

Here, date printing refers to printing an image containing a date as shown in FIG. 1, for example. The date printing is also referred to as date print. The date printing generally involves, but not limited to, printing a photographing date on a target image. The photographing date and time can also be printed on the target image. The photographing date information is obtained from exchangeable image file format information (Exif information) of the target image data. In the date printing, the photographing date data is obtained from the Exif information of the target image data, and the obtained photographing date data is printed on the target image. To print the photographing date and time, the photographing date and time data is obtained from the Exif information of the target image data, and the obtained photographing date and time data is printed on the target image. The following description is given of an example of printing the photographing date on the target image. A plurality of setting items such as output size, the number of copies, and date printing are included in print setting. A setting value (setting content) is set for each setting item. The setting value for each setting item can be changed using a program (communication application) on the information processing apparatus.

### Hardware Configuration of Each Apparatus

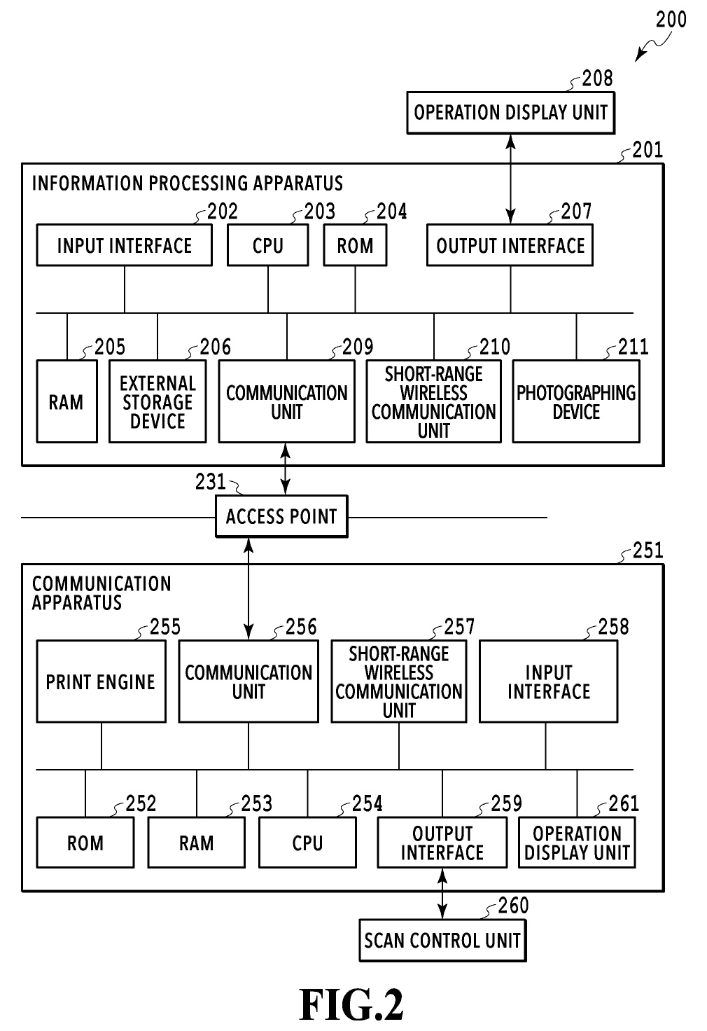

FIG. 2 is a block diagram showing configurations of an information processing apparatus 201 and a communication apparatus 251 capable of communicating with the information processing apparatus 201, which are included in a print system 200 of the present embodiment. Although the following configurations are described as an example in the present embodiment, the functions of the apparatuses in the present embodiment are not limited thereto.

The information processing apparatus 201 includes an input interface 202, a CPU 203, a ROM 204, a RAM 205, an external storage device 206, an output interface 207, an operation display unit 208, a communication unit 209, a short-range wireless communication unit 210, and a photographing device 211. The input interface 202 is an interface for receiving data input and operation instructions from the user, and includes a physical keyboard, buttons, a touch panel, and the like. In other words, the input interface includes hard keys and soft keys displayed on the touch panel. Note that the output interface 207 to be described later and the input interface 202 may have the same configuration, and the same configuration may be used for screen output and receiving user operations.

The CPU 203 is a system control unit configured to control the entire information processing apparatus 201. The ROM 204 stores fixed data such as a control program executed by the CPU 203, data tables, and an embedded operating system (hereinafter referred to as “OS”) program. In the present embodiment, each control program stored in the ROM 204 performs software execution control such as scheduling, task switching, and interrupt processing under the control of the embedded OS stored in the ROM 204.

The RAM 205 is composed of a static random access memory (SRAM) or the like, which requires a backup power source. The RAM 205 retains data using a primary battery (not shown) for data backup, allowing important data such as program control variables to be stored without volatilization. The RAM 205 also includes a memory area for storing setting information of the information processing apparatus 201, management data of the information processing apparatus 201, and the like. The RAM 205 is also used as a main memory and a work memory for the CPU 203.

The external storage device 206 is a hard disk drive (HDD), solid state drive (SSD), flash memory, cloud storage or the like. The external storage device 206 stores an application program (hereinafter referred to as the “communication app”) having a function to communicate with the communication apparatus 251. Specifically, the communication app is, for example, an application with a print function for causing the communication apparatus 251 to execute printing and a scan function for causing the communication apparatus 251 to execute scanning. However, the communication app is not limited to this configuration, and may be an application with functions other than the print function and the scan function. The external storage device 206 also stores various programs, such as a print information generation program for generating print information that can be interpreted by the communication apparatus 251, and an information transmission and reception control program for transmission and reception to and from the communication apparatus 251 connected through the communication unit 209. The external storage device 206 also stores various information used by these programs. The external storage device 206 also stores image data obtained from other information processing apparatuses or the Internet through the communication unit 209.

The output interface 207 is an interface for performing control to display data on the operation display unit 208 and to notify a state of the information processing apparatus 201. The operation display unit 208 includes a light emitting diode (LED) and a display device such as a liquid crystal display (LCD) or a touch panel, and displays data and notifies the state of the information processing apparatus 201. Note that a soft keyboard equipped with keys such as numeric input keys, a mode setting key, a confirm key, a cancel key, and a power key may be provided on the operation display unit 208 to receive input from the user through the operation display unit 208. The confirm, cancel, and power keys may also be provided as separate hard keys.

The communication unit 209 connects to an apparatus such as the communication apparatus 251 to perform data communication. For example, the communication unit 209 can connect to an access point (not shown) within the communication apparatus 251. Connecting the communication unit 209 to the access point within the communication apparatus 251 enables the information processing apparatus 201 and the communication apparatus 251 to communicate with each other. The access point may also be hereinafter referred to as “AP”. The communication unit 209 may communicate directly with the communication apparatus 251 via wireless communication, or may communicate through an access point 231 located outside the information processing apparatus 201 and the communication apparatus 251. In the present embodiment, the IEEE 802.11 series of communication standards is used as the wireless communication method. Specifically, the IEEE 802.11 series of communication standards is Wi-Fi (registered trademark).

Examples of the access point 231 include a wireless LAN router and the like. In the present embodiment, a method in which the information processing apparatus 201 and the communication apparatus 251 connect directly without going through an external access point is referred to as a direct connection mode. On the other hand, a method in which the information processing apparatus 201 and the communication apparatus 251 connect through the external access point 231 is referred to as an infrastructure (hereinafter referred to as “infra”) connection mode.

The short-range wireless communication unit 210 is configured to perform data communication through short-range wireless connection with apparatuses such as the communication apparatus 251 using a communication method different from that used by the communication unit 209. Examples of the short-range wireless communication method used by the short-range wireless communication unit 210 include Bluetooth (registered trademark) and near field communication (NFC). Bluetooth may be Bluetooth Classic or Bluetooth Low Energy. The short-range wireless communication unit 210 can be connected to a short-range wireless communication unit 257 in the communication apparatus 251. The photographing device 211 converts images captured by an imaging device into digital data. The digital data is temporarily stored in the RAM 205. The digital data is then converted into a predetermined image format by a program executed by the CPU 203 and stored as image data in the external storage device 206.

The communication apparatus 251 includes a ROM 252, a RAM 253, a CPU 254, a print engine 255, a communication unit 256, the short-range wireless communication unit 257, an input interface 258, an output interface 259, an operation display unit 260, and a scan control unit 261. The ROM 252 stores fixed data such as a control program executed by the CPU 254, data tables, and an OS program. In the present embodiment, the control program stored in the ROM 252 performs software execution control such as scheduling, task switching, and interrupt processing under the control of the embedded OS stored in the ROM 252. The ROM 252 also includes a memory area for storing data that need to be retained also in a case where no power is supplied, such as setting information of the communication apparatus 251 and management data of the communication apparatus 251.

The RAM 253 is composed of a DRAM or the like that requires a backup power source. The RAM 253 retains data by receiving a data backup power supply (not shown), and thus can store important data such as program control variables without volatilization. The RAM 253 is also used as a main memory and a work memory for the CPU 254, and stores various information and a receive buffer for temporarily storing print information received from the information processing apparatus 201 or the like.

The CPU 254 is a system control unit configured to control the entire communication apparatus 251. The print engine 255 forms an image on a print medium such as paper using a printing material such as ink and toner, based on the information stored in the RAM 253 and a print job received from the information processing apparatus 201 or the like, and outputs the print result. The communication apparatus 251, such as an inkjet printer and an inkjet multifunction peripheral for inkjet printing, uses ink to perform printing. The communication apparatus 251 for electrophotographic printing uses toner to perform printing. In this case, the print job transmitted from the information processing apparatus 201 or the like has a large amount of transmission data and requires high-speed communication. Therefore, the communication apparatus 251 receives the print job data through the communication unit 256 capable of communication at a higher speed than the short-range wireless communication unit 257.

The communication apparatus 251 can operate in a configured connection mode by setting the connection mode (communication mode). The communication unit 256 is configured to allow the communication apparatus 251 to communicate with other apparatuses. In the present embodiment, the communication unit 256 uses the IEEE 802.11 series of communication standards to communicate with other apparatuses. The communication unit 256 has an access point, as an access point inside the communication apparatus 251, for connecting to apparatuses such as the information processing apparatus 201. This access point can be connected to the communication unit 209 of the information processing apparatus 201. The communication unit 256 may communicate directly with the information processing apparatus 201 via wireless communication, or may communicate through the access point 231. The communication unit 256 may be equipped with hardware that functions as an access point, or may operate as an access point using software for allowing the communication unit 256 to function as the access point. In the present embodiment, the communication unit 256 and the short-range wireless communication unit 257 are implemented in a single wireless chip. Specifically, in the present embodiment, a combo chip is used that supports both the communication function using the IEEE 802.11 series of communication standards and the communication function using the short-range wireless communication method. However, the present disclosure is not limited to this configuration, and the communication unit 256 and the short-range wireless communication unit 257 may each be implemented by separate wireless chips.

The short-range wireless communication unit 257 is configured to perform data communication by establishing a short-range wireless connection with apparatuses such as the information processing apparatus 201 using a communication method different from that of the communication unit 256. The short-range wireless communication method used by the short-range wireless communication unit 210 is, for example, Bluetooth (registered trademark) or NFC. Bluetooth may be Bluetooth Classic or Bluetooth Low Energy. The short-range wireless communication unit 257 is connectable to the short-range wireless communication unit 210.

The input interface 258 is an interface for receiving data input and operation instructions from the user, and includes a physical keyboard, buttons, a touch panel, and the like. In other words, the input interface includes hard keys and soft keys displayed on the touch panel. Note that the output interface 259 to be described later and the input interface 258 may have the same configuration, so that the same configuration can be used for screen output and receiving user operations. The output interface 259 is an interface for performing control to display data by the operation display unit 260 and to notify the state of the communication apparatus 251.

The operation display unit 260 includes a light emitting diode (LED) and a display device such as a liquid crystal display (LCD) or a touch panel, and displays data and notifies the state of the communication apparatus 251. Note that a soft keyboard equipped with keys such as numeric input keys, a mode setting key, a confirm key, a cancel key, and a power key may be provided on the operation display unit 260 to receive input from the user through the operation display unit 260.

The scan control unit 261 includes an image sensor unit (reading unit) configured to scan a document placed on a document table or an auto document feeder (ADF) (not shown). The image sensor unit includes a light source for irradiating the document with light and an image sensor with an array of elements that read the reflected light for photoelectric conversion. The scan control unit 261 obtains image data by performing analog-digital (A/D) conversion of an analog electric signal obtained by the image sensor unit reading the document. The scan control unit 261 also includes a circuit for performing direct memory access (DMA) transfer to store the obtained image data in the RAM 253.

In a software AP mode, one of the communicating apparatuses (for example, the information processing apparatus 201 and the communication apparatus 251), that is, the information processing apparatus 201, for example, serves as a client that requests various services. The other apparatus (for example, the communication apparatus 251) implements the function of a Wi-Fi access point through software setting. The software AP corresponds to a Wi-Fi master station, while the client corresponds to a Wi-Fi slave station. In the software AP mode, the client searches for an apparatus that serves as the software AP using apparatus search information. Once the software AP is found, the client and the software AP complete the remaining wireless connection processing (such as establishing a wireless connection), and then executes IP connection processing (such as assigning an IP address). As for commands and parameters transmitted and received upon establishing the wireless connection between the client and the software AP, those defined by the Wi-Fi standard may be used, and description thereof will be omitted here.

### Configuration of Communication Application Communication App

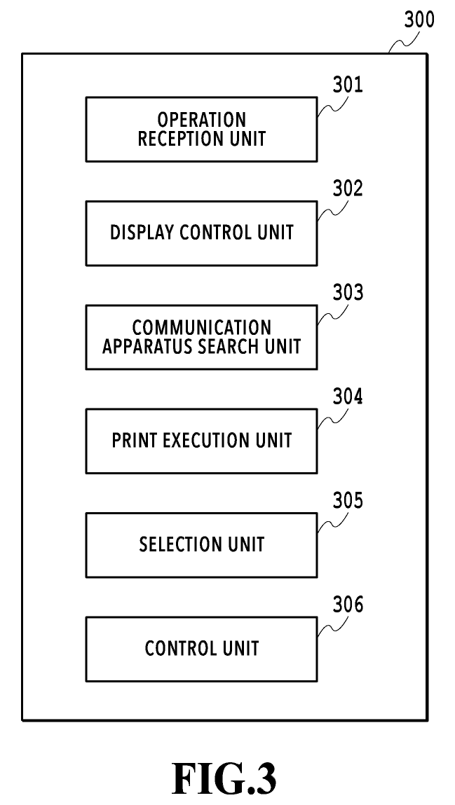

FIG. 3 is a diagram showing a configuration of the communication application stored in the ROM 204 and the external storage device 206 of the information processing apparatus 201. The communication application is an application program with a print function and the like for allowing the communication apparatus 251 that function as a printer or printing apparatus to print image data or document data in the information processing apparatus 201. The communication application also has a function of importing image data or document data scanned by the communication apparatus 251 into the information processing apparatus 201.

A communication app 300 includes an operation reception unit 301, a display control unit 302, a communication apparatus search unit 303, a print execution unit 304, a selection unit 305, and a control unit 306. Each program module is executed by the CPU 203 to implement the respective functions. In the present embodiment, the communication app 300 receives an operation performed on the operation display unit 208 through the operation reception unit 301. The display control unit 302 controls the display on the operation display unit 208 by the communication app 300. As an example, a list of searched printers (communication apparatuses 251) is displayed on the operation display unit 208 of the information processing apparatus 201. The communication apparatus search unit 303 searches for a printer (communication apparatus 251) that can be used by the communication app 300.

The print execution unit 304 transmits selected print target data to the selected communication apparatus 251, causing the communication apparatus 251 to print the print target data. The print target data may be, for example, document data or image data stored upon start-up of the communication app 300. The print target data may also be data obtained from a cloud server or the communication apparatus 251, or may be data obtained from another data source. The selection unit 305 selects an image or various processing and the like in response to input received through the operation reception unit 301.

The control unit 306 controls the processing of the information processing apparatus 201 executed by the communication app 300. As an example, based on a fact that the selected print target data includes predetermined information, the control unit 306 performs control to include an area for changing date printing setting in a change screen or preview screen. Additionally, if setting to support the execution of date printing is configured as the date printing setting, the control unit 306 also performs control to print a character string corresponding to date information included in the predetermined information upon printing based on the print target data.

In the following description, processing described as being executed by the units of the communication app 300 is, more precisely, processing implemented by the CPU 203 reading the communication app stored in the ROM 204 or the like into the RAM 205 and executing the app. For printing, the print execution unit 304 generates a print job and transmits the generated print job to the communication apparatus 251 (that is, the printer). The communication apparatus 251 executes the received print job for printing.

### Operation of Communication Application

The operation of the communication app 300 running on the information processing apparatus 201 will be described below. The following drawings, except for the flowcharts, show a state where the operation display unit 208 of the information processing apparatus 201 is using the communication app 300 stored in the external storage device 206 of the information processing apparatus 201. Specifically, screens provided by the display control unit 302 of the communication app 300 are displayed in the following drawings.

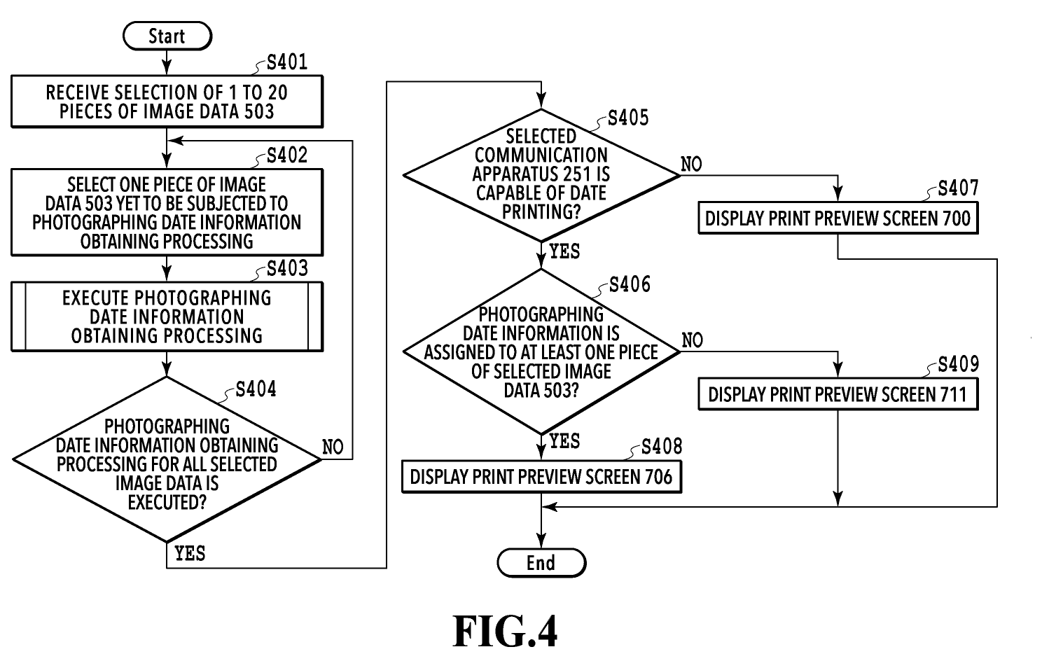

With reference to FIG. 4, description will be given of processing of the communication app 300 from receiving the selection of image data to transitioning to a print preview screen. FIG. 4 is a flowchart showing the processing of the communication app 300 from receiving the selection of image data to transitioning to the print preview screen. The processing of the communication app 300 shown in FIG. 4 is implemented by the CPU 203 expanding the communication app 300 stored in the ROM 204 or the like into the RAM 205 and executing the app.

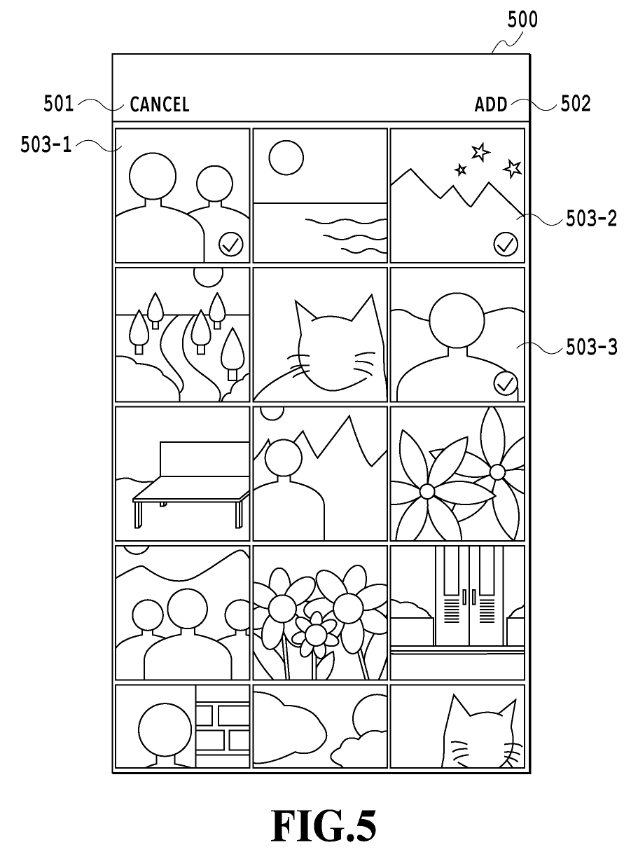

In S401, the CPU 203 executes control to display a selection screen for receiving the selection of print target image data from the user. Specifically, for example, the CPU 203 instructs the OS via the communication app 300 to display the selection screen. In this event, the CPU 203 instructs the OS via the communication app 300 as to the type of image data to be displayed on the selection screen. The type of image data notified in this event is, for example, what is called a Media type or MINE type. Specifically, for example, the CPU 203 notifies “image” as the Media type or MINE type. Note that examples of extensions corresponding to “image” include PNG, BMP, GIF, JPEG, HEIF, HEIC, and TIFF. Here, PNG is an abbreviation for Portable Network Graphics. BMP is an abbreviation for Bitmap. GIF is an abbreviation for Graphics Interchange Format. JPEG is an abbreviation for Joint Photographic Experts Group. HEIF is an abbreviation for High Efficiency Image File Format. HEIC is an abbreviation for High Efficiency Image Codec. TIFF is an abbreviation for Tag Image File Format. Also, examples of extensions other than those corresponding to “image” include an extension corresponding to “document” such as PDF and an extension corresponding to “video” such as MP3 and MP4. PDF is an abbreviation for Portable Document Format. The OS then displays a selection screen using its filer function. The displayed selection screen is controlled to include image data with the extension corresponding to “image” and exclude data with extensions other than the extension corresponding to “image”. In a case where one or more pieces of image data are selected in the selection screen, the OS notifies the communication app 300 of information indicating the one or more pieces of image data selected in the selection screen. This allows the communication app 300 to know the one or more pieces of image data selected in the selection screen and various information about the image data. A selection screen 500 of FIG. 5 is an example of a selection screen displayed in this processing. Upon receiving the pressing of an add button 502 in the selection screen 500, the CPU 203 closes the selection screen 500. In FIG. 5, the selection screen 500 for selecting image data to be printed by the communication apparatus 251 is displayed on the operation display unit 208 of the information processing apparatus 201. The displayed image data is image data stored in the information processing apparatus 201. This screen is displayed by the filer function of the OS, and includes a cancel button 501 and the add button 502. Selecting the cancel button 501 closes the selection screen 500. The add button 502 cannot be selected unless one or more pieces of image data are selected. The image data can be selected or deselected by tapping the screen. Tapping once selects the image data, and tapping the same image data again deselects the image data. In the present embodiment, the maximum number of pieces of image data that can be selected at one time in the selection screen 500 is, but not limited to, 20, and any number may be used as the maximum. Here, the selected image data is referred to as image data 503. The selection screen 500 is closed as the add button 502 is selected while the image data 503 is selected. As the selection screen 500 is closed, information indicating one or more pieces of image data selected in the selection screen 500 is notified to the communication app 300. Note that the control for displaying the selection screen is not limited to the above-described configuration. For example, the CPU 203 may perform this control by requesting image data to be displayed in the selection screen from the OS via the communication app 300. Specifically, for example, the CPU 203 may notify “image” as the Media type or MINE type. This may cause the communication app 300 to obtain image data with the extension corresponding to “image” and display a selection screen for receiving an operation to select one or more pieces of image data from the obtained image data. This selection screen is also controlled so as to include image data with the extension corresponding to “image” and to exclude data with extensions other than the extension corresponding to “image”. In this event, the CPU 203 may also obtain thumbnails corresponding to the image data from the OS, display a list of the obtained thumbnails in the selection screen, and obtain image data corresponding to the thumbnail selected in the selection screen from the OS.

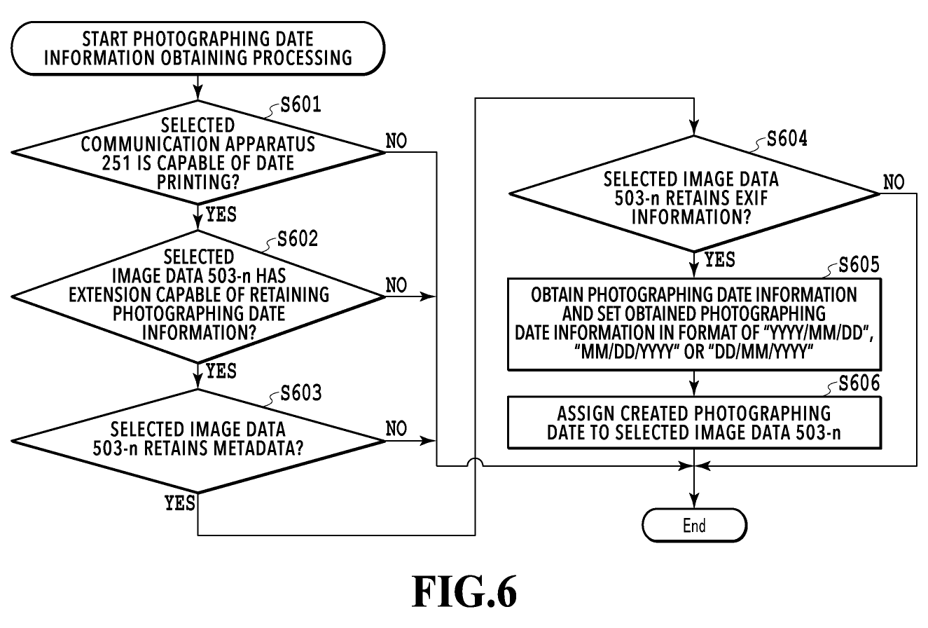

In S402, the CPU 203 selects one piece of image data yet to be subjected to photographing date information obtaining processing, from among the one or more pieces of image data selected in S401. In the present embodiment, the image data selected in S401, for example, is referred to as image data 503-1 to 503-3. To describe the one piece of image data selected in S402, the image data is referred to as image data 503-n. To collectively describe the image data 503-1 to 503-3, the image data is referred to as image data 503. In S403, the CPU 203 executes the photographing date information obtaining processing shown in FIG. 6 for the image data 503-n selected in S402.

FIG. 6 is a flowchart showing the details of the photographing date information obtaining processing. The processing of the communication app 300 shown in FIG. 6 is implemented by the CPU 203 expanding the communication app 300 stored in the ROM 204 or the like into the RAM 205 and executing the app. In S601, the CPU 203 confirms whether the selected communication apparatus 251 is capable of date printing. In a case where the selected communication apparatus 251 is capable of date printing, the processing proceeds to S603. In a case where the selected communication apparatus 251 is not capable of date printing, the photographing date information obtaining processing shown in FIG. 6 ends.

In S602, the CPU 203 confirms whether the selected image data 503-n has a specific extension (type) corresponding to a file extension capable of retaining photographing date information. In a case where the extension of the selected image data 503-n is the specific extension, the processing proceeds to S603. In a case where the extension of the selected image data 503-n is not the specific extension and corresponds to a file extension that cannot retain the photographing g date information, the photographing date information obtaining processing shown in FIG. 6 ends. Concrete examples of the specific extension include JPEG, HEIF, HEIC, and TIFF. Concrete examples of the extension that are not the specific extension include PNG, BMP, and GIF.

In S603, the CPU 203 confirms whether the selected image data 503-n retains metadata. Even if the selected image data 503-n has the specific extension, the selected image data 503-n may not contain metadata including the photographing date information and the like, and thus S603 is performed. In a case where the selected image data 503-n retains the metadata, the processing proceeds to S604. In a case where the selected image data 503-n does not retain the metadata, the photographing date information obtaining processing shown in FIG. 6 ends.

In S604, the CPU 203 confirms whether the selected image data 503-n retains Exif information. Even if the selected image data 503-n contains the metadata, the selected image data 503-n may not have the Exif information, and thus S604 is performed. In a case where the selected image data 503-n retains the Exif information, the processing proceeds to S605. In a case where the selected image data 503-n does not retain the Exif information, the photographing date information obtaining processing shown in FIG. 6 ends. Here, Exif is an abbreviation for Exchangeable Image File Format.

Since the Exif information includes information on the photographing date and time, date printing is performed by obtaining data on the photographing date and time from the Exif information of the selected image data 503-n, and converting the obtained data on the photographing date and time into the photographing date. The obtained data on the photographing date and time may also be printed as is without converting the data into the photographing date.

In S605, the CPU 203 obtains photographing date information from the Exif information of the selected image data 503-n and converts the date into a character string to be printed upon printing the date. In the present embodiment, the character string to be printed is one of “yyyy/mm/dd”, “mm/dd/yyyy”, and “dd/mm/yyyy”. Here, “yyyy” represents the year in the Gregorian calendar, “mm” represents the month, and “dd” represents the day. The Exif information also includes information indicating the time of photographing of the image data. However, in the present embodiment, the time of photographing of the image data is controlled so as not to be included in the character string to be printed upon printing the date. The present disclosure is, however, not limited to this configuration, and the time of photographing of the image data may also be controlled so as to be included in the character string to be printed upon printing the date.

In S606, the CPU 203 assigns the character string of the date created in S605 to the selected image data 503-n as the photographing date information. Specifically, the CPU 203 performs control to print the character string of the date at the lower right portion of the image represented by the selected image data 503-n. The present disclosure is not limited to this configuration, and the CPU 203 may perform control to print the character string of the date somewhere else than the lower right portion of the image represented by the selected image data 503-n. Specifically, the CPU 203 may perform control to print the character string of the date outside the image represented by the selected image data 503-n. The photographing date information obtaining processing shown in FIG. 6 then ends. After the photographing date information obtaining processing is performed on all selected image data, all selected image data is temporarily stored in the information processing apparatus 201 as data to be printed.

Back to the processing in the flowchart of FIG. 4, the CPU 203 determines in S404 whether the date information obtaining processing is performed on all image data selected in S401. In a case where it is determined that the photographing date information obtaining processing is not performed on all image data, the processing returns to S402. In a case where it is determined that the photographing date information obtaining processing is performed on all image data, the processing proceeds to S405.

In S405, before transitioning to the print preview screen, the CPU 203 determines whether the selected communication apparatus 251 is capable of date printing. Specifically, the CPU 203 determines whether the selected communication apparatus 251 is a model capable of date printing. In the present embodiment, a model for printing using the electrophotographic method is the model capable of date printing, and a model for inkjet type printing is a model that is not capable of date printing. The present disclosure is, however, not limited to this configuration, and the model for inkjet type printing may also be included as the model capable of date printing. If all communication apparatuses 251 supported by the communication app 300 are capable of date printing, this determination may be omitted and the processing may proceed to S406. In a case where it is determined that the selected communication apparatus 251 is capable of date printing, the processing proceeds to S406. In a case where it is determined that the selected communication apparatus 251 is not capable of date printing, the processing proceeds to S407.

In S406, the CPU 203 confirms whether the photographing date information is assigned in S403 to at least one piece of the image data 503 selected in S401. In a case where the photographing date information is assigned to at least one piece of the selected image data 503 in S403, the processing proceeds to S408. In a case where the photographing date information is assigned to none of the selected image data 503 in S403, the processing proceeds to S409.

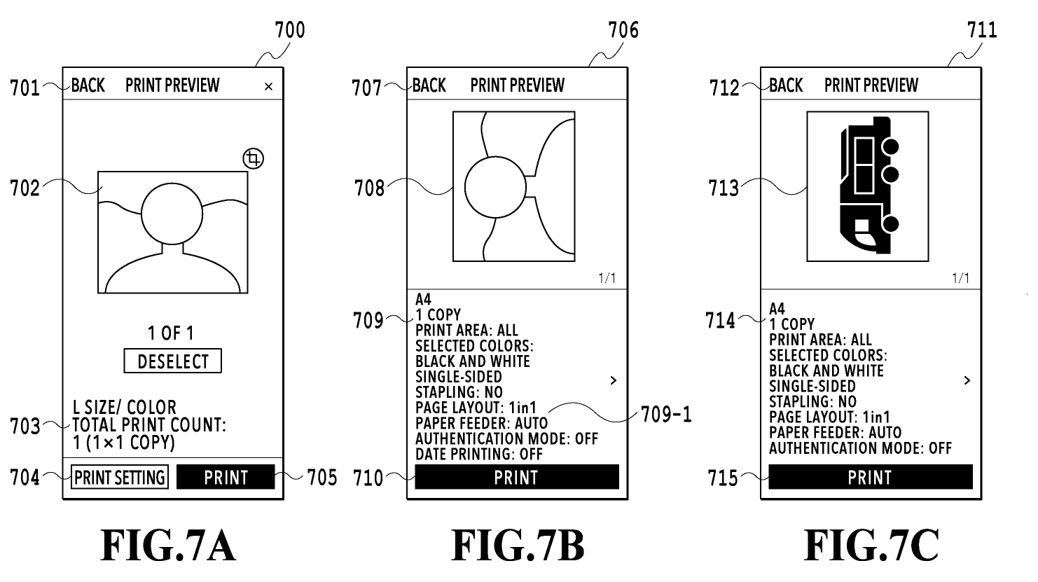

In S407, the CPU 203 displays a print preview screen 700 of FIG. 7A on the operation display unit 208, and ends the processing of the flowchart shown in FIG. 4. FIG. 7A shows the print preview screen 700 displayed in a case where the communication apparatus 251 capable of date printing is not selected by the CPU 203. The print preview screen 700 includes a back button 701, a preview display area 702, a print setting display area 703, a print settings button 704, and a print button 705. The print setting display area 703 is controlled so as not to include (display) areas related to date printing, such as an area 709-1 to be described later.

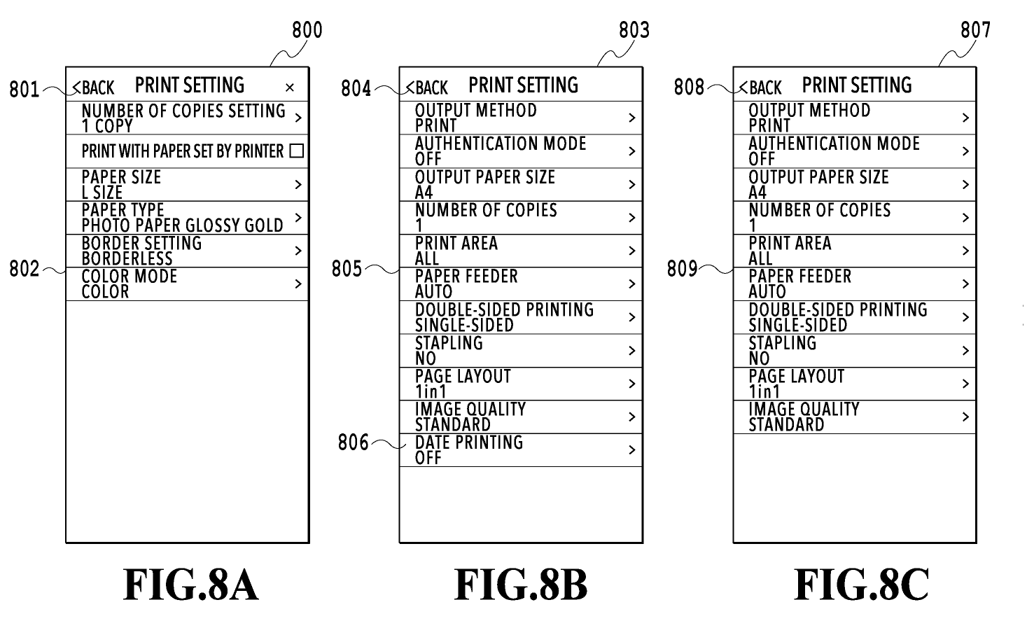

Pressing the back button 701 closes the print preview screen 700. The preview display area 702 displays the image data 503 selected in the selection screen 500. In a case where a plurality of images are selected, one of them is displayed. The preview display area 702 allows swipe operation (slide operation) to change the image data displayed in the preview display area 702. The print setting display area 703 displays a plurality of setting items of print setting for printing using the selected communication apparatus 251. Pressing (touching) the print setting display area 703 makes transition to a print setting screen 800 of FIG. 8A, where the setting items of the print setting displayed in the print setting display area 703 can be set to desired setting values. Pressing the print setting button 704 also makes transition to the print setting screen 800 of FIG. 8A, as in the case of pressing the print setting display area 703. As the print button 705 is pressed, the communication app 300 creates print data using the set print setting, and then the created print data is transmitted to the communication apparatus 251.

FIG. 8A shows the print setting screen 800 displayed in a case where the communication apparatus 251 capable of date printing is not selected by the CPU 203 (communication app 300). The print setting screen 800 is a change screen including a back button 801 and a print setting area 802 for changing the setting values of the print setting items. By selecting a desired print setting item on this change screen, the setting value of the selected print setting item can be changed. Pressing the back button 801 closes the print setting screen 800, and the display on the operation display unit 208 returns to the print preview screen 700 shown in FIG. 7A. The print setting area 802 displays a plurality of setting items of the print setting for printing using the selected communication apparatus 251. Note that even if the selected image data 503 retains the photographing date information, the following control is executed in a case where the selected communication apparatus 251 is not capable of date printing. Specifically, the print setting area 802 is controlled so as not to display setting items and setting values of date printing, such as a date printing setting 806 to be described later.

In S408, the CPU 203 displays a print preview screen 706 of FIG. 7B to be described later on the operation display unit 208, and then ends the processing of the flowchart shown in FIG. 4. Specifically, in a case where the image data displayed on the print preview screen 706 in S408 contains predetermined information such as the Exif information, and the conditions for selecting the communication apparatus 251 capable of date printing are met, date printing is enabled.

FIG. 7B shows the print preview screen 706 displayed in a case where the communication apparatus 251 capable of date printing is selected by the CPU 203 and date printing is enabled with the selected image data 503. The print preview screen 706 includes a back button 707, a preview display area 708, a print setting display area 709, and a print button 710.

The print preview screen 706 is closed by pressing the back button 707. The preview display area 708 displays the image data 503 selected in the selection screen 500. In a case where a plurality of images are selected, one of them is displayed. The selected image data 503 is enlarged by pressing the preview display area 708. In a case where a plurality of images are selected, the enlarged area can be swiped to change the image data displayed in the preview display area 708. The print setting display area 709 displays an area related to a plurality of setting items of print setting for printing using the selected communication apparatus 251. This area includes the area 709-1 related to date printing setting items. The area includes an area indicating that date printing setting items can be set as the print setting for printing the currently displayed image data, and an area indicating the setting values currently set for the date printing setting items. Note that default setting (initial setting) for date printing setting values is off. Pressing the print setting display area 709 makes transition to a print setting screen 803 of FIG. 8B, where a plurality of setting items of print setting displayed in the print setting display area 709 can be set to desired values. As the print button 710 is pressed, the communication app 300 creates print data using the print setting displayed in the print setting display area 709, and then the created print data is transmitted to the communication apparatus 251. In a case where the date printing setting value is set to ON, the CPU 203 creates print data and then transmits the created print data to the communication apparatus 251 so that the photographing date information is displayed at the lower right corner of the print data.

Even if the date printing setting value is set to ON, the photographing date information is not displayed in the preview display area 708. The present disclosure is, however, not limited to this configuration. The photographing date information may be displayed in the preview display area 708 with the date printing setting value set to ON.

FIG. 8B shows the print setting screen 803 displayed in a case where the communication apparatus 251 capable of date printing is selected by the CPU 203 (communication app 300) and date printing is enabled with the selected image data 503. The print setting screen 803 includes a back button 804 and a print setting area 805. The print setting screen 803 is closed by pressing the back button 804, and the display on the operation display unit 208 returns to the print preview screen 706 shown in FIG. 7B. The print setting area 805 displays a plurality of setting items of print setting for printing using the selected communication apparatus 251. The date printing setting 806 indicating the setting items and setting values for date printing is also displayed in the print setting area 805. Pressing the date printing setting 806 makes transition to a screen for setting whether to perform date printing. On the setting screen after the transition, the date printing setting can be set to ON or OFF. The default setting is OFF.

In S409, the CPU 203 displays a print preview screen 711 of FIG. 7C to be described later on the operation display unit 208, and ends the processing of the flowchart shown in FIG. 4. Note that even if the selected plurality of pieces of image data 503 do not include any image data containing the photographing date information and only include image data containing file creation date information, the transition is made to the print preview screen 711 of FIG. 7C, and then the processing of the flowchart shown in FIG. 4 ends. In the present embodiment, the screen displayed in S407 is different from the screen displayed in S409. The present disclosure is, however, not limited to this configuration, and the screen displayed in S407 and the screen displayed in S409 may be the same.

FIG. 7C shows the print preview screen 711 displayed in a case where the communication apparatus 251 capable of date printing is selected by the CPU 203, but date printing cannot be performed with the selected image data 503. The print preview screen 711 includes a back button 712, a preview display area 713, a print setting display area 714, and a print button 715. The print setting display area 714 is controlled so as not to include (display) areas related to date printing, such as the area 709-1 described above.

The print preview screen 711 is closed by pressing the back button 712. The preview display area 713 displays the image data 503 selected in the selection screen 500. In a case where a plurality of images are selected, one of them is displayed. The selected image data 503 is enlarged by pressing the preview display area 713. In a case where a plurality of images are selected, the enlarged area can be swiped to change the image data displayed in the preview display area 713. As described above, the print setting display area 714 displays a plurality of setting items of print setting for printing using the selected communication apparatus 251, but does not display setting items and setting values for date printing. Pressing the print setting display area 714 makes transition to a print setting screen 807 of FIG. 8C, where the plurality of setting items of print setting displayed in the print setting display area 714 can be set to desired values. As the print button 715 is pressed, the communication app 300 creates print data using the print setting displayed in the print setting display area 714, and then the created print data is transmitted to the communication apparatus 251. Since date printing is not enabled, print data for date printing is not created even if file creation date information is retained.

FIG. 8C shows the print setting screen 807 displayed in a case where the communication apparatus 251 capable of date printing is selected by the CPU 203 (communication app 300), but date printing cannot be performed with the selected image data 503. The print setting screen 807 includes a back button 808 and a print setting area 809. The print setting screen 807 is closed by pressing the back button 808, and the display on the operation display unit 208 returns to the print preview screen 711 shown in FIG. 7C. The print setting area 809 displays a plurality of setting items of print setting for printing using the selected communication apparatus 251, but is controlled so as not to display setting items and setting values for date printing, such as the date print setting 806 described above. Even if the selected image data 503 retains file creation date information, the setting value of date printing is not displayed and date printing cannot be performed, since the image data 503 retaining the photographing date information is not selected.

In the above-described embodiment, in S406 of the flowchart in FIG. 4, it is determined whether the photographing date information is assigned to at least one piece of the selected image data 503. In a case where the photographing date information is assigned to at least one piece of the selected image data 503, the processing proceeds to S408. In a case where the photographing date information is not assigned to any of the selected image data 503, the processing proceeds to S407. The present disclosure is, however, not limited to this configuration. For example, in S406, it may be determined whether the photographing date information is assigned to all of the selected image data 503. In a case where the selected image data 503 includes at least one piece of data with no photographing date information assigned thereto, the processing may proceed to S407. In a case where the photographing date information is assigned to all of the selected image data 503, the processing may proceed to S408. The communication app 300 can switch the data displayed on the preview screen in response to a user operation. Therefore, for example, the print preview screen 706 is displayed as a preview screen for displaying a piece of the selected image data 503 to which the photographing date information is assigned. On the other hand, control may be performed to display the print preview screen 711 as a preview screen for displaying a piece of the selected image data 503 to which the photographing date information is not assigned.

Note that the print preview screen 711 shown in FIG. 7C may be displayed even if the plurality of selected image data 503 do not include data with the photographing date information assigned thereto and only include data with the file creation date information assigned thereto. Specifically, in a case where the selected image data 503-n retains file creation date information (or file update date information), that information may be obtained and the date may be incorporated into the character string to be printed upon printing the date. The character string of the date thus formed may then be assigned as the file creation date information. However, in this case, the photographing date information assigned in S606 is controlled as being different from the file creation date information.

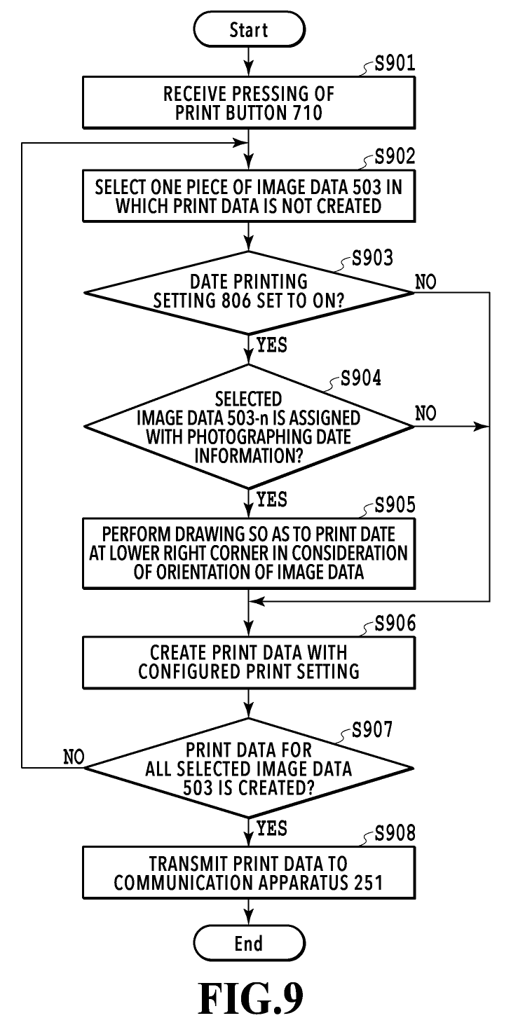

Next, description will be given of processing upon receipt of the pressing of the print button 710 on the print preview screen 706 displayed in a case where the CPU 203 (communication app 300) selects the communication apparatus 251 capable of date printing and the date printing is enabled with the selected image data 503. Specifically, description will be given of processing up to the transmission of print data to the communication apparatus 251 after the receipt of the pressing of the print button 710 in FIG. 7B. FIG. 9 is a flowchart showing processing of the communication app 300 up to the transmission of print data to the communication apparatus 251 after receiving the pressing of the print button 710 displayed on the print preview screen 706. The processing of the communication app 300 shown in FIG. 9 is implemented by the CPU 203 expanding the communication app 300 stored in the ROM 204 or the like into the RAM 205 and executing the app.

In S901, the CPU 203 receives the pressing of the print button 710 displayed on the print preview screen 706. In S902, the CPU 203 selects one piece of image data 503 yet to be used to create print data, from the image data selected in S901. In S903, the CPU 203 confirms whether the date printing setting 806 in FIG. 8A is ON or OFF. In a case where the date printing setting 806 is ON, the processing proceeds to S904. In a case where the date printing setting 806 is OFF, the processing proceeds to S906.

In S904, the CPU 203 confirms whether the image data 503-n selected in S902 is assigned with the photographing date information by the photographing date information obtaining processing shown in FIG. 6. In a case where the photographing date information is assigned, the processing proceeds to S905. In a case where the photographing date information is not assigned, the processing proceeds to S906.

In S905, in a case where the photographing date information is assigned to the image data 503-n selected in S902, the CPU 203 performs drawing processing taking into consideration the orientation of the image data 503-n so that the photographing date information is printed at the lower right corner of the print result.

In S906, the CPU 203 creates print data using print setting other than date printing. In S907, the CPU 203 confirms whether print data is created for all of the selected image data 503. In a case where print data is not created for all of the selected image data 503, the processing returns to S902. In a case where print data is created for all of the selected image data 503, the processing proceeds to S908. In S908, the CPU 203 transmits the created print data to the communication apparatus 251, and then ends the processing of the flowchart shown in FIG. 9. As for the print data for all of the selected image data 503, setting items and setting values of print setting other than the setting items and setting values of date printing are displayed on the preview screen or change screen for changing the setting values of the setting items.

As described above, the communication app 300 selects the communication apparatus 251 capable of date printing and confirms whether the image data 503 assigned with the photographing date information is selected. Furthermore, appropriate UI display is provided to ensure the user can reliably perform date printing using the photographing date. This makes it possible to not only provide the user with the intended function for date printing, but also reduce false recognition of the user. This improves usability of date printing.

In the above description, the following control mode is executed. The display control on the preview screen is executed so that the date printing area is not displayed in FIGS. 7A and 7C, but is displayed in FIG. 7B. Furthermore, control is also executed where both display control modes on the print setting change screen are executed so that the date printing area is not displayed in FIGS. 8A and 8C, but is displayed in FIG. 8B. The present disclosure is, however, not limited to these modes. For example, only one of the display control on the preview screen and the display control on the print setting change screen may be executed. In a mode where only the display control on the preview screen is executed, for example, the date printing area may be displayed in all of FIGS. 8A to 8C. In a mode where only the display control on the print setting change screen is executed, for example, the date printing area may be displayed in all of FIGS. 7A to 7C. Alternatively, the date printing area does not have to be displayed in all of FIGS. 7A to 7C. Furthermore, not only the date printing area but also the areas for the other print setting items do not have to be displayed in all of FIGS. 7A to 7C.

The technology according to the present disclosure improves usability of date printing.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-004740, filed January 14, 2025, which is hereby incorporated by reference herein in its entirety.

What is claimed is:

1. A non-transitory computer readable storage medium storing a program which causes a computer to execute a method of controlling an information processing apparatus, the method comprising:
a selecting step of selecting print target data;
a first displaying step of displaying a change screen for changing print setting used in printing based on the selected print target data;
a first controlling step of controlling the change screen to include an area for changing date printing setting, based on a fact that predetermined information is assigned to the selected print target data, and controlling the change screen to not include the area for changing the date printing setting, based on a fact that the predetermined information is not assigned to the selected print target data;
a second controlling step of controlling printing based on the print target data so as to print a character string corresponding to date information included in the predetermined information, in a case where setting corresponding to execution of the date printing is configured as the date printing setting, and controlling printing based on the print target data so as not to print the character string corresponding to the date information included in the predetermined information, in a case where setting corresponding to non-execution of the date printing is configured as the date printing setting; and
an executing step of executing processing for printing based on the print target data.

2. The storage medium according to claim 1, further comprising:
a second displaying step of displaying a preview screen for previewing the selected print target data, wherein
the preview screen transitions to the change screen based on a user operation on the preview screen.

3. The storage medium according to claim 2, further comprising:
a third controlling step of controlling the preview screen to include an area indicating a setting value for the date printing setting, based on a fact that the predetermined information is assigned to the selected print target data, and controlling the preview screen to not include the area indicating the setting value for the date printing setting, based on a fact that the predetermined information is not assigned to the selected print target data.

4. The storage medium according to claim 3, wherein a type of the print target data is one of a Joint Photographic Experts Group (JPEG) format, a High Efficiency Image File Format (HEIF), a High Efficiency Image Codec (HEIC) format, and a Tag Image File Format (TIFF).

5. The storage medium according to claim 3, wherein the predetermined information is Exchangeable Image File Format (Exif) information.

6. The storage medium according to claim 5, wherein the first controlling step and the second controlling step are executed in a case where a printing apparatus for printing the print target data is an electrophotographic printer or an electrophotographic multifunction peripheral.

7. The storage medium according to claim 5, wherein the first controlling step and the second controlling step are not executed in a case where a printing apparatus is an inkjet printer or an inkjet multifunction peripheral.

8. The storage medium according to claim 3, wherein, in a case where a plurality of pieces of the print target data are selected in the second displaying step, one piece of print target data is displayed on the preview screen from among the plurality of pieces of print target data.

9. The storage medium according to claim 8, wherein, in the second displaying step, the print target data displayed among the plurality of pieces of print target data is switched by performing a slide operation on the preview screen.

10. The storage medium according to claim 8, wherein an area for changing the date printing setting is displayed on the change screen for the print target data assigned with the predetermined information, in a case where the predetermined information is assigned to at least one of the plurality of pieces of print target data in the first controlling step.

11. The storage medium according to claim 8, wherein an area indicating a setting value of the date printing setting is displayed on the preview screen for the print target data assigned with the predetermined information, in a case where the predetermined information is assigned to at least one of the plurality of pieces of print target data in the third controlling step.

12. The storage medium according to claim 8, wherein an area for changing the date printing setting is not displayed on the change screen for the print target data, in a case where the predetermined information is not assigned to any of the plurality of pieces of print target data in the first controlling step.

13. The storage medium according to claim 8, wherein an area indicating a setting value of the date printing setting is not displayed on the preview screen for the print target data , in a case where the predetermined information is not assigned to any of the plurality of pieces of print target data in the third controlling step.

14. The storage medium according to claim 3, wherein an area for changing setting for other than date printing is displayed on the change screen for the selected print target data, regardless of whether the predetermined information is assigned to the selected print target data in the first controlling step.

15. The storage medium according to claim 3, wherein an area indicating a setting value of setting for other than date printing is displayed on the preview screen for the selected print target data, regardless of whether the predetermined information is assigned to the selected print target data in the third controlling step.

16. The storage medium according to claim 1, wherein an initial setting of the date printing setting is set to OFF in the first controlling step.

17. The storage medium according to claim 16, wherein a date character string in the date printing setting is one of “yyyy/mm/dd”, “mm/dd/yyyy”, and “dd/mm/yyyy”, where “yyyy” represents a year in a Gregorian calendar, “mm” represents a month, and “dd” represents a day.

18. The storage medium according to claim 17, wherein the date character string is disposed at a lower right portion of the selected print target data.

19. An information processing apparatus, comprising:
one or more processors and/or circuitry which function as:
a selection unit configured to select print target data;
a display control unit configured to display a change screen for changing print setting used in printing based on the selected print target data;
a first control unit configured to control the change screen to include an area for changing date printing setting, based on a fact that predetermined information is assigned to the selected print target data, and to control the change screen to not include the area for changing the date printing setting, based on a fact that the predetermined information is not assigned to the selected print target data;
a second control unit configured to control printing based on the print target data so as to print a character string corresponding to date information included in the predetermined information, in a case where setting corresponding to execution of the date printing is configured as the date printing setting, and to control printing based on the print target data so as not to print the character string corresponding to the date information included in the predetermined information, in a case where setting corresponding to non-execution of the date printing is configured as the date printing setting; and
an execution unit configured to execute processing for printing based on the print target data.

20. A method of controlling an information processing apparatus, comprising:
a selecting step of selecting print target data;
a displaying step of displaying a change screen for changing print setting used in printing based on the selected print target data;
a first controlling step of controlling the change screen to include an area for changing date printing setting, based on a fact that predetermined information is assigned to the selected print target data, and controlling the change screen to not include the area for changing the date printing setting, based on a fact that the predetermined information is not assigned to the selected print target data;
a second controlling step of controlling printing based on the print target data so as to print a character string corresponding to date information included in the predetermined information, in a case where setting corresponding to execution of the date printing is configured as the date printing setting, and controlling printing based on the print target data so as not to print the character string corresponding to the date information included in the predetermined information, in a case where setting corresponding to non-execution of the date printing is configured as the date printing setting; and
an executing step of executing processing for printing based on the print target data.
